(19) United States
(12) Patent Application Publication
(10) Pub. No.: US 2025/0246741 A1
(43) Pub. Date: Jul. 31, 2025

(54) TRACTION BATTERY PACK SERVICE PANEL

(71) Applicant: Ford Global Technologies, LLC, Dearborn, MI (US)

(72) Inventors: Rajaram Subramanian, Ann Arbor, MI (US); Hari Krishna Addanki, Novi, MI (US); Steve Droste, Canton, MI (US); Suriyaprakash Ayyangar Janarthanam, Canton, MI (US)

(21) Appl. No.: 18/425,150

(22) Filed: Jan. 29, 2024

(51) Int. Cl. H01M 50/262; B60L 50/60; H01M 50/224; H01M 50/249

(52) U.S. Cl. CPC H01M 50/262; B60L 50/60; H01M 50/224; H01M 50/249; H01M 2220/20

(57) ABSTRACT

A battery assembly includes an enclosure providing an interior. The enclosure has a wall and a service panel. The service panel is secured to the wall with at least one snap-lock seam to cover a service opening in the wall. A method includes securing a service panel to a wall of an enclosure using at least one snap-lock seam. The service panel covers a service opening in the wall when secured to the wall.

### TECHNICAL FIELD

This disclosure relates to a service panel and, more particularly, to securing a service panel to a traction battery pack enclosure using at least one snap-lock seam.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines.

### SUMMARY

In some aspects, the techniques described herein relate to a battery assembly, including: an enclosure providing an interior, the enclosure having a wall and a service panel, the service panel secured to the wall with at least one snap-lock seam to cover a service opening in the wall.

In some aspects, the techniques described herein relate to a battery assembly, wherein the enclosure is a metal or metal alloy.

In some aspects, the techniques described herein relate to a battery assembly, wherein the service panel is a metal or metal alloy.

In some aspects, the techniques described herein relate to a battery assembly, wherein the service panel is secured to the wall exclusively using the at least one snap-lock seam.

In some aspects, the techniques described herein relate to a battery assembly, wherein the at least one snap-lock seam includes a plurality of snap-lock seams distributed about the service opening when the service panel is secured to the wall.

In some aspects, the techniques described herein relate to a battery assembly, wherein the service opening includes a plurality of corners, the plurality of snap-lock seams each disposed a distance from each corner within the plurality of corners.

In some aspects, the techniques described herein relate to a battery assembly, wherein the at least one snap-lock seam includes a flange received within a channel.

In some aspects, the techniques described herein relate to a battery assembly, further including at least one barb of the flange, the at least one barb configured to resist withdrawal of the flange from the channel.

In some aspects, the techniques described herein relate to a battery assembly, wherein the at least one barb is configured to contact an edge face of a lip to resist withdrawal, the lip disposed within the channel.

In some aspects, the techniques described herein relate to a battery assembly, wherein the service panel include the flange and the wall includes the channel.

In some aspects, the techniques described herein relate to a battery assembly, wherein the interior accommodates at least one battery internal component accessible through the service opening.

In some aspects, the techniques described herein relate to a battery assembly, wherein the enclosure and the service panel are constituents of a traction battery pack of an electrified vehicle.

In some aspects, the techniques described herein relate to a battery assembly, wherein the service panel is secured to the wall with the at least one snap-lock seam and without mechanical fasteners.

In some aspects, the techniques described herein relate to a method, including: securing a service panel to a wall of an enclosure using at least one snap-lock seam, the service panel covering a service opening in the wall when secured to the wall.

In some aspects, the techniques described herein relate to a method, wherein the enclosure is a metal or metal alloy.

In some aspects, the techniques described herein relate to a method, further including receiving a flange within a channel during the securing.

In some aspects, the techniques described herein relate to a method, further including using a barb to block withdrawal of the flange from the channel.

In some aspects, the techniques described herein relate to a method, wherein the barb contact an edge of a lip to block withdrawal of the flange from the channel.

In some aspects, the techniques described herein relate to a method, wherein the service panel includes the flange and the wall includes the channel.

In some aspects, the techniques described herein relate to a method, wherein exclusively the at least one snap-lock seam secures the service panel to the wall of the enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of an example powertrain for an electrified vehicle.

FIG. 2 illustrates a perspective, schematic view of the battery pack of FIG. 1 with a service panel shown in a disengaged position to reveal a service opening in a cover of an enclosure.

FIG. 3 illustrates the perspective view of FIG. 2 with the cover removed.

FIG. 4 illustrates a close-up of the service panel when secured a wall of the enclosure.

FIG. 5 illustrates a close-up partial section view of a portion of the service panel moving to a position where the service panel is secured to the wall of the enclosure.

FIG. 6 illustrates the view of FIG. 5 after the service panel has been secured to the wall of the enclosure.

### DETAILED DESCRIPTION

This disclosure relates to a service panel that can cover a service opening that is in an enclosure of a traction battery pack and, more particularly, how the service panel is attached. If required, components within the enclosure can be accessed for service through the service opening.

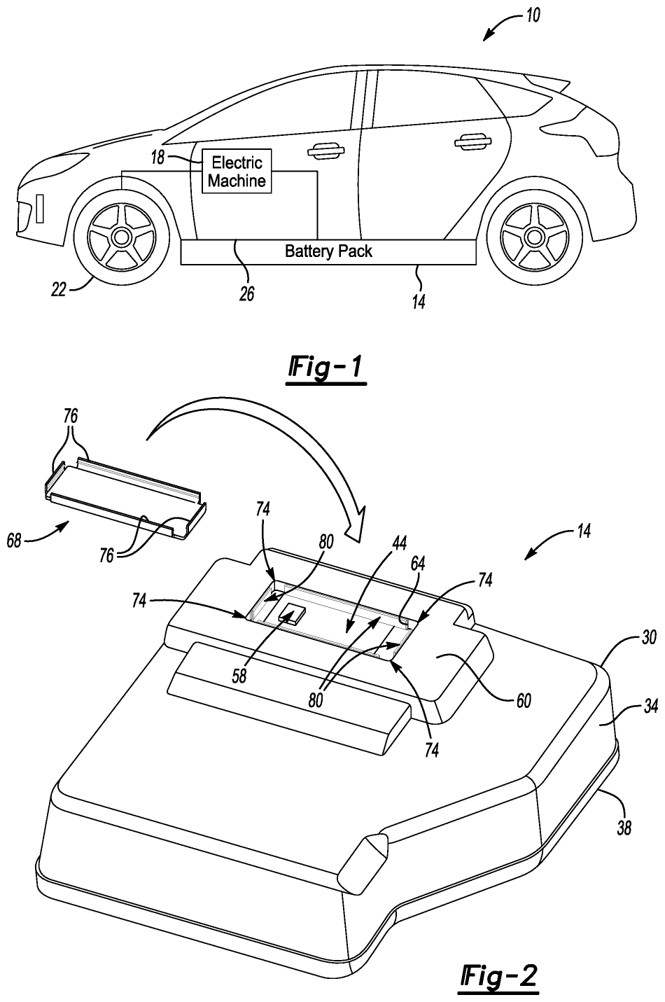

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

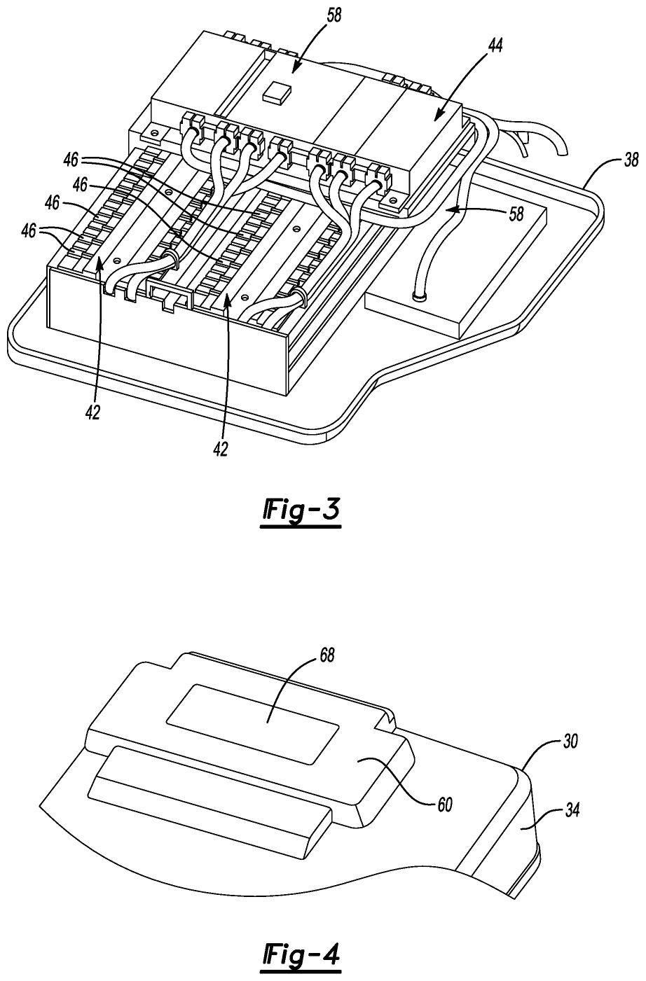

FIGS. 2 and 3 illustrate an example of the battery pack 14 that can be employed within the electrified vehicle 10 of FIG. 1. FIG. 2 is a perspective view of the battery pack 14, and FIG. 3 illustrates the battery pack 14 with select portions removed for visualizing the internal contents of the battery pack 14.

In this example, the battery pack 14 includes an enclosure 30. The enclosure 30 includes a cover 34 and a tray 38. The cover 34, in this example, is vertically above the tray 38. In other examples, however, the cover 34 could be arranged below, or to a side of the tray 38.

The cover 34 is attached to the tray 38 in one example of this disclosure with a plurality of mechanical fasteners. A seal material could be incorporated at the interface between the cover 34 and the tray 38 to block contaminants and moisture from entering the battery pack 14. While fastening with a seal is mentioned, the cover 34 and tray 38 could be connected using other fluid-tight connection techniques, such as adhesive. Further, while an exemplary enclosure 30 is shown in the drawings, the enclosure 30 may vary in size, shape, and configuration within the scope of this disclosure.

In this embodiment, the enclosure 30 houses at least one cell stack 42 within an interior 44 of the enclosure 30. The cell stack 42 includes a plurality of individual battery cells 46 disposed along an axis. The cell stack 42 could include any number of battery cells 46. Further, while the example battery pack 14 includes two cell stacks 42, other examples could employ any number of cell stacks 42 within the enclosure 30. Thus, this disclosure is not limited to the exact configuration shown in FIG. 2.

The battery cells 46 store energy for powering various electrical loads of the electrified vehicle 12. In an embodiment, the battery cells 46 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery pack 24 may house one or more battery electronic components 58 within the enclosure 30 in addition to the cell stacks 42. The battery electronic component 58 could include a bussed electrical center (BEC), a battery electric control module (BECM), wiring harnesses, wiring loops, I/O connectors, etc., or any combination of these battery electronic components.

Other exemplary battery electronic components 58 include a battery control module (BCM), a bussed electrical center (BEC), a control module, electronics, high voltage electrical cabling, a fuse, a battery cell (if the cell stacks 42 are serviceable), or any other component of the traction battery pack 14. The battery electronic components 58 could instead, or additionally, include other components assisting with control and/or management of the traction battery pack 14.

The cell stacks 42 and the battery electronic components 58 can be referred to as battery internal components of the battery pack 24 as the cells stacks 42 and the battery electronic components 58 are housed inside the enclosure 30.

In an embodiment, the enclosure 30 can be a metal or metal alloy, such as aluminum or steel. In some examples, the cover 34, the tray 38, or both could be constructed from aluminum or steel in combination with polymer-based materials.

In the example embodiment, the enclosure 30 is a sealed enclosure. For example, during assembly, the battery internal components may be positioned on the tray 38, and the cover 34 may then be fixedly secured to the tray 38 to seal the battery internal components therein. In this embodiment, the cover 34 is fastened to the tray 38 with a seal, thus creating a substantially leak proof joint.

From time to time, one or more of the battery internal components may require servicing (e.g., repair or replacement) during the life of the battery pack 14. Serviceable components, for purposes of this disclosure, can include any of the battery internal components that can be repaired, replaced, or evaluated to permit continued use of the traction battery pack 14 within the vehicle 10. As can be appreciated, repair, replacement, or evaluation can require access to the serviceable component within the enclosure 30. Access points can potentially provide passages for moisture and contaminants to enter the interior 44.

To facilitate service, a wall 60 of the enclosure 30 includes a service opening 64 that provides access to the interior 44 when the cover 34 is sealed to the tray 38. The service opening 64 is in the cover 34 in this example. In other example, the service opening 64 could be partially or fully within the tray 38.

The enclosure 30 includes a service panel 68 that covers the service opening 64 unless battery internal components are being serviced. FIG. 4 shows the service panel 68 secured to the wall 60 of the enclosure 30. The wall 60 could be part of either the tray 38 or the cover 34 of the enclosure 30. Like the wall 60, the service panel 68 can be a metal or metal alloy.

The service panel 68 can be disengaged from the wall 60 to provide access to the interior 44 through the service opening 64. The battery internal components can be accessed and serviced through the opening without requiring the complete disassembly of the enclosure 30.

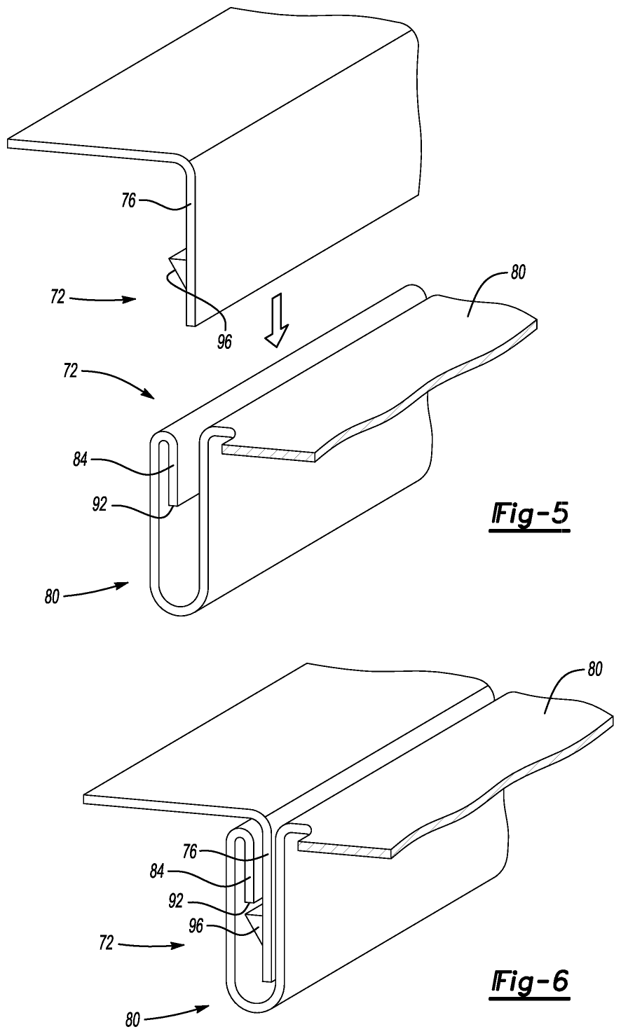

With reference to FIGS. 5 and 6 and continuing reference to FIGS. 2-4, to facilitate disengagement from the wall 60, the service panel 68 is secured to the wall 60 with one or more snap-lock seams 72. The service panel 68, in this example, is secured to the wall 60 with a four of the snap-lock seams 72 that are distributed about the service opening 64 when the service panel 68 is secured to the wall 60.

The snap-lock seams 72 do not extend all the way into corners 74 of the service opening 64. That is, the snap-lock seams 72 are spaced a distance from the corners 74. This can facilitate forming the snap-lock seams 72 by reducing potential areas of interference. Further, the corners 74 can the provide an area for engaging with the service panel 68. For example, a technician can insert a pry tool beneath the service panel 68 near the corner 74 to slightly raise the service panel 68 away from the wall 60 so that the service panel 68 can be gripped and removed by disengaging the snap-lock seams 72.

When the snap-lock seams 72 are securing the service panel 68 to the wall 60, the service panel 68 covers the service opening 64 as shown in FIG. 4 to block movement of moisture and contaminants into the interior 44, and to block access to the interior 44.

The snap-lock seams 72 are linear. The snap-lock seams 72 are, in this example, the only way that the service panel 68 is secured to the wall 60. That is, no additional mechanical fasteners, such as clips, bolts, or screws, are used to secure the service panel 68 to the wall 60. In some examples, an adhesive sealant could be disposed about the service opening 64 and used to seal interfaces between the wall 60 and the service panel 68.

The snap-lock seams 72 each include a flange 76 received within a channel 80. In this example, the flange 76 is part of the service panel 68, and the channel 80 is provided by the wall 60. In another example, the flange 76 is part of the wall 60, and the channel 80 is provided by the service panel 68.

The channel 80 has a U-shape. The channel 80 is positioned to open outward away from the interior 44. The channel 80 can be formed using a bending process.

An edge portion 84 of the wall 60 is hemmed or folded over back into the channel 80 to establish a lip within the channel 80. An edge face 92 of the wall 60 faces away from the open end of the channel 80.

The flange 76 includes at least one barb 96. The flange 76 can be pressed into the channel 80 until the at least one barb 96 moves past the edge face 92. Contact between the at least one barb 96 and the edge face 92 resists withdrawal of the flange 76 from the channel 80.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery assembly, comprising:
an enclosure providing an interior, the enclosure having a wall and a service panel, the service panel secured to the wall with at least one snap-lock seam to cover a service opening in the wall.

2. The battery assembly of claim 1, wherein the enclosure is a metal or metal alloy.

3. The battery assembly of claim 2, wherein the service panel is a metal or metal alloy.

4. The battery assembly of claim 1, wherein the service panel is secured to the wall exclusively using the at least one snap-lock seam.

5. The battery assembly of claim 1, wherein the at least one snap-lock seam comprises a plurality of snap-lock seams distributed about the service opening when the service panel is secured to the wall.

6. The battery assembly of claim 5, wherein the service opening includes a plurality of corners, the plurality of snap-lock seams each disposed a distance from each corner within the plurality of corners.

7. The battery assembly of claim 1, wherein the at least one snap-lock seam includes a flange received within a channel.

8. The battery assembly of claim 7, further comprising at least one barb of the flange, the at least one barb configured to resist withdrawal of the flange from the channel.

9. The battery assembly of claim 8, wherein the at least one barb is configured to contact an edge face of a lip to resist withdrawal, the lip disposed within the channel.

10. The battery assembly of claim 7, wherein the service panel include the flange and the wall includes the channel.

11. The battery assembly of claim 1, wherein the interior accommodates at least one battery internal component accessible through the service opening.

12. The battery assembly of claim 1, wherein the enclosure and the service panel are constituents of a traction battery pack of an electrified vehicle.

13. The battery assembly of claim 1, wherein the service panel is secured to the wall with the at least one snap-lock seam and without mechanical fasteners.

14. A method, comprising:
securing a service panel to a wall of an enclosure using at least one snap-lock seam, the service panel covering a service opening in the wall when secured to the wall.

15. The method of claim 14, wherein the enclosure is a metal or metal alloy.

16. The method of claim 14, further comprising receiving a flange within a channel during the securing.

17. The method of claim 16, further comprising using a barb to block withdrawal of the flange from the channel.

18. The method of claim 17, wherein the barb contact an edge of a lip to block withdrawal of the flange from the channel.

19. The method of claim 16, wherein the service panel includes the flange and the wall includes the channel.

20. The method of claim 14, wherein exclusively the at least one snap-lock seam secures the service panel to the wall of the enclosure.
